(19) United States
(12) Patent Application Publication
(10) Pub. No.: US 2006/0155068 A1
(43) Pub. Date: Jul. 13, 2006

(54) Rubber composition, production process thereof, process for producing molded article containing vulcanized rubber composition, and vibration-proof material

(75) Inventors: Sadayuki Nakano, Ichihara-shi (JP); Junichi Koshiba, Ichihara-shi (JP); Akio Mase, Kasugai-shi (JP); Norihito Kimura, Kasugai-shi (JP)

Correspondence Address: SUGHRUE MION, PLLC, 2100 PENNSYLVANIA AVENUE, N.W., SUITE 800, WASHINGTON, DC, 20037, US

(73) Assignees: SUMITOMO CHEMICAL COMPANY; LIMITED and TOKAI RUBBER INDUSTRIES, LTD.

(21) Appl. No.: 11/300,400

(22) Filed: Dec. 15, 2005

(30) Foreign Application Priority Data
Dec. 16, 2004 (JP) P2004-364070

(51) Int. Cl. C08F 8/00

(52) U.S. Cl. 525/192

(57) ABSTRACT

A rubber composition containing no reinforcing agent, which comprises (A) 55 to 95 parts by weight of an ethylene-α-olefin-non-conjugated diene copolymer rubber, (B) 5 to 45 parts by weight of a natural rubber, and (C) 0.1 to 15 parts by weight of an organic peroxide, wherein the total amount of the components (A) and (B) is 100 parts by weight; a process for producing a rubber composition comprising the steps of (1) kneading at least said components (A) and (B), and (2) mixing at least the kneaded product with said component (C); a process for producing a molded article containing a vulcanized rubber composition, which comprises the above kneading step (1), the above mixing step (2), and the step (3) of molding the rubber composition at elevated temperature; and a vibration-proof material which comprises a molded article containing a vulcanized rubber composition produced according to the above-mentioned process.

### FIELD OF THE INVENTION

The present invention relates to a rubber composition; a process for producing a rubber composition; a process for producing a molded article containing a vulcanized rubber composition; and a vibration-proof material.

### BACKGROUND OF THE INVENTION

JP 6-200096A discloses a process for producing a vibration-proof material, which contains a rubber composition obtained from a combination of 50 parts by weight or more of an ethylene-propylene-based polymer, less than 50 parts by weight of a natural rubber, carbon black (reinforcing agent) in an amount represented by the following formula, and a peroxide:
A≦0.4X+30
wherein A is an amount of carbon black (part by weight), and X is an amount of the ethylene-propylene-based polymer, the total amount of the ethylene-propylene-based polymer and the natural rubber being 100 parts by weight.

### SUMMARY OF THE INVENTION

However, a vibration-proof material produced according to said process is insufficient in its high-temperature durability.

An object of the present invention is to provide (1) a vibration-proof material having excellent high-temperature durability, (2) a process for producing a molded article containing a vulcanized rubber composition, which article is suitably used for producing said vibration-proof material, (3) a rubber composition suitably used for producing said molded article containing a vulcanized rubber composition, and (4) a process for producing said rubber composition. The above-mentioned “excellent high-temperature durability” means large elongation at break under a constant load at high temperature.

The present invention is a rubber composition, which comprises the following components (A), (B) and (C):

(A) 55 to 95 parts by weight of an ethylene-α-olefin-non-conjugated diene copolymer rubber;

(B) 5 to 45 parts by weight of a natural rubber; and

(C) 0.1 to 15 parts by weight of an organic peroxide, wherein the total amount of the components (A) and (B) is 100 parts by weight, and the rubber composition contains no reinforcing agent.

Also, the present invention is a process for producing a rubber composition containing no reinforcing agent, which comprises the steps of:

(1) kneading at least the following components (A) and (B),
(A) 55 to 95 parts by weight of an ethylene-α-olefin-non-conjugated diene copolymer rubber, and
(B) 5 to 45 parts by weight of a natural rubber, thereby producing a kneaded product; and

(2) mixing at least the kneaded product with the following component (C),
(C) 0.1 to 15 parts by weight of an organic peroxide, wherein the total amount of the components (A) and (B) is 100 parts by weight.

Further, the present invention is a process for producing a molded article containing a vulcanized rubber composition, which comprises the steps of:

(1) kneading at least the following components (A) and (B),
(A) 55 to 95 parts by weight of an ethylene-α-olefin-non-conjugated diene copolymer rubber, and
(B) 5 to 45 parts by weight of a natural rubber, thereby producing a kneaded product;

(2) mixing at least the kneaded product with the following component (C),
(C) 0.1 to 15 parts by weight of an organic peroxide, thereby producing a rubber composition; and

(3) molding the rubber composition at elevated temperature,

wherein the total amount of the components (A) and (B) is 100 parts by weight, and the rubber composition produced in the step (2) contains no reinforcing agent.

Still further, the present invention is a vibration-proof material, which comprises a molded article containing a vulcanized rubber composition produced according to the above-mentioned process for producing a molded article containing a vulcanized rubber composition.

### DETAILED DESCRIPTION OF THE INVENTION

The component (A) means a copolymer of ethylene, an α-olefin having 3 to 20 carbon atoms and a non-conjugated diene having 3 to 20 carbon atoms. Examples of the α-olefin are propylene, 1-butene, 1-pentene, 1-hexene, 4-methyl-1-pentene, 1-octene and 1-decene. Among them, preferred is propylene or 1-butene.

The above-mentioned non-conjugated diene can be used in combination with other non-conjugated polyene such as a non-conjugated triene. Namely, the component (A) may be an ethylene-α-olefin-non-conjugated diene-non-conjugated polyene copolymer rubber such as an ethylene-α-olefin-non-conjugated diene-non-conjugated triene copolymer rubber. Examples of the non-conjugated diene are a linear non-conjugated diene such as 1,4-hexadiene, 1,6-octadiene, 2-methyl-1,5-hexadiene, 6-methyl-1,5-heptadiene, 7-methyl-1,6-octadiene, 4-ethylidene-8-methyl-1,7-nonadiene, and 5,9,13-trimethyl-1,4,8,12-tetradecadiene; a cyclic non-conjugated diene such as cyclohexadiene, dicyclopentadiene, 5-vinylnorbornene, 5-ethylidene-2-norbornene, 6-chloromethyl-5-isopropenyl-2-norbornene, 2-propenyl-2,2-norbornadiene, 5-vinyl-2-norbornene, 5-(2-propenyl)-2-norbornene, 5-(3-butenyl)-2-norbornene, 5-(4-pentenyl)-2-norbornene, 5-(5-hexenyl)-2-norbornene, 5-(5-heptenyl)-2-norbornene, 5-(7-octenyl)-2-norbornene, and 5-methylene-2-norbornene; and a combination of two or more thereof. Examples of the non-conjugated polyene are 2,3-diisopropylidene-5-norbornene, 2-ethylidene-3-isopropylidene-5-norbornene, 1,3,7-octatriene, 1,4,9-decatriene, 6,10-dimethyl-1,5,9-undecatriene, 5,9-dimethyl-1,4,8-decatriene, 13-ethyl-9-methyl-1,9,12-pentadecatriene, 8,14,16-trimethyl-1,7,14-hexadecatriene, and 4-ethylidene-12-methyl-1,11-pentadecadiene; and a combination of two or more thereof. Among them, preferred is 5-ethylidene-2-norbornene, dicyclopentadiene or a combination thereof.

The component (A) contains an ethylene unit in an amount of preferably 40 to 80% by weight, and more preferably 45 to 65% by weight, and contains an α-olefin unit in an amount of preferably 20 to 60% by weight, and more preferably 35 to 55% by weight, wherein the total amount of both units is 100% by weight. The amount of larger than 80% by weight of an ethylene unit results in such an extreme deterioration of a low-temperature resistance of a vulcanized rubber composition that a temperature dependence of its dynamic magnification is remarkably large, and therefore, a vibration-proof performance at room temperature may not be brought out in a winter season or in cold climates. The amount of smaller than 40% by weight of an ethylene unit may result in deterioration of a high-temperature durability of a vulcanized rubber composition. The above-mentioned dynamic magnification is represented by the following formula:
d=K′/K
wherein d is dynamic magnification; K is a constant of spring of a vibration-proof material in a static state (namely, static elastic modulus); and K′ is a constant of spring thereof in a dynamic state (namely, dynamic elastic modulus). Here, “dynamic state” is a state of a sinusoidal oscillation. The smaller the dynamic magnification is, the better the vibration-proof performance is. In the present invention, a monomer unit such as the above-mentioned “ethylene unit” is a unit of a polymerized monomer.

The component (A) has a Mooney viscosity (ML₁₊₄ 125° C.) of preferably 50 to 180, and more preferably 55 to 160. The Mooney viscosity of smaller than 50 may result in remarkable deterioration of a high-temperature durability of a vulcanized rubber composition. The Mooney viscosity of larger than 180 may result in remarkable deterioration of kneading processability of a rubber composition.

The component (A) contains a non-conjugated diene unit in an amount of preferably 5 to 36, and more preferably 8 to 30 in terms of an iodine value, wherein said amount is the total amount of a non-conjugated diene unit and other non-conjugated polyene unit such as a non-conjugated triene unit in case that a non-conjugated diene is used in combination with other non-conjugated polyene. Said amount of smaller than 5 in terms of an iodine value may result in deterioration of a high-temperature durability of a vulcanized rubber composition because of an insufficient crosslinking density thereof. Said amount of larger than 36 in terms of an iodine value may result in a large dynamic magnification of a vulcanized rubber composition.

Examples of the component (A) are an ethylene-propylene-5-ethylidene-2-norbornene copolymer and an ethylene-propylene-dicyclopentadiene copolymer. When the component (A) is a combination of two or more of copolymers, respective amounts of the above-mentioned ethylene unit and α-olefin unit contained in said combination, the above-mentioned Mooney viscosity, and the above-mentioned iodine value are those for said combination.

The component (A) may be combined with an extender such as an oily substance. Said combination is called an extended rubber in the art.

A process for producing the component (A) is not particularly limited, and it can be produced according to a process known in the art. Examples of a polymerization catalyst used for producing the component (A) are a titanium-containing catalyst, a vanadium-containing catalyst, and a metallocene catalyst known in the art.

The component (B) has a Mooney viscosity (ML₁₊₄ 100° C.) of preferably 20 to 180, and more preferably 30 to 170. The Mooney viscosity of smaller than 20 may result in remarkable deterioration of tensile strength of a vulcanized rubber composition. The Mooney viscosity of larger than 180 may result in remarkable deterioration of kneading processability of a rubber composition.

Examples of the component (C) are dicumyl peroxide, 2,5-dimethyl-2,5-di(tert-butylperoxy)hexane, 2,5-dimethyl-2,5-di(benzoylperoxy)hexane, 2,5-dimethyl-2,5-bis(tert-butylperoxy)hexyne-3, di-tert-butyl peroxide, di-tert-butylperoxide-3,3,5-trimethylcyclohexane, and tert-butyl hydroperoxide. Among them, particularly preferred is dicumyl peroxide, di-tert-butyl peroxide or di-tert-butylperoxide-3,3,5-trimethylcyclohexane.

Since the present invention uses no reinforcing agent, a vibration-proof material of the present invention has a small dynamic magnification; namely, the vibration-proof material has an excellent vibration-proof performance.

The above-mentioned reinforcing agent means additives added to a rubber in order to improve physical properties of a vulcanized product of the rubber, such as hardness, tensile strength, modulus, impact resilience and tear strength, which is mentioned in HANDBOOK OF ADDITIVES FOR RUBBER AND PLASTIC issued by Rubber Digest. Examples of the reinforcing agent are channel carbon black such as EPC, MPC and CC; furnace carbon black such as SAF, ISAF, HAF, MAF, FEF, SRF, GPF, APF, FF, CF, SCF and ECF; thermal carbon black such as FT and MT; acetylene carbon black; dry-process silica; wet-process silica; synthetic silicate-based silica; colloidal silica; basic magnesium carbonate; active calcium carbonate; heavy calcium carbonate; light calcium carbonate; mica; magnesium silicate; aluminum silicate; a high-styrene resin; a cyclized rubber; a cumarone-indene resin; a phenol-formaldehyde resin; a vinyltoluene copolymer resin; lignin; aluminum hydroxide; and magnesium hydroxide.

Any of the components (A), (B) and (C) is preferably combined with tetramethylthiuram monosulfide (hereinafter referred to “component (D)”) in order to improve a heat resistance of a rubber composition of the present invention, of a rubber composition produced according to the process of the present invention, of a molded article containing a vulcanized rubber composition produced according to the process of the present invention, and of a vibration-proof material of the present invention. The component (D) is used in an amount of preferably 0.05 to 10 parts by weight, and more preferably 0.5 to 8 parts by weight, per 100 parts by weight of the total amount of the components (A) and (B). The amount of the component (D) of smaller than 0.05 part by weight may result in an insufficient improvement of the above-mentioned heat resistance. The amount of the component (D) of larger than 10 parts by weight may hardly result in a further improvement of the above-mentioned heat resistance.

An amount of the component (A) is 55 to 95 parts by weight, and preferably 55 to 75 parts by weight, and an amount of the component (B) is 5 to 45 parts by weight, and preferably 25 to 45 parts by weight, wherein the total amount of both components is 100 parts by weight. The amount of the component (A) of smaller than 55 parts by weight may result in extreme deterioration of the above-mentioned heat resistance. The amount of the component (A) of larger than 95 parts by weight may result in extreme deterioration of tensile strength of a molded article containing a vulcanized rubber composition.

The rubber composition of the present invention can be produced according to the above-mentioned process comprising the steps (1) and (2).

The step (1) is a step of kneading at least the components (A) and (B) with a conventional internal mixer such as a Banbury mixer and a kneader, thereby producing a kneaded product.

The component (C) is used in the step (2) in an amount of 0.1 to 15 parts by weight, and preferably 0.5 to 8 parts by weight, per 100 parts by weight of the total amount of the components (A) and (B). The step (2) is a step of mixing at least the kneaded product produced in the step (1) with the component (C) with a conventional kneader such as a roll and a kneader, at 100° C. or lower in order to inhibit decomposition of the component (C), thereby producing a rubber composition capable of being vulcanized by heating. The component (C) is not substantially decomposed in the step (2); namely, the rubber composition produced in the step (2) contains the substantially total amount of the component (C) used in the step (2).

Any of the components (A) and (B) used in the step (1), or any of the kneaded product and the component (C) used in the step (2) may be combined with a material such as a compounding agent (for example, plasticizer, vulcanization accelerator, vulcanizing agent, and vulcanizing auxiliary agent), a resin (for example, polyethylene resin and polypropylene resin), and a rubber other than the components (A) and (B) (for example, styrene-butadiene rubber, chloroprene rubber, acrylonitrile-butadiene rubber, acrylic rubber, butadiene rubber, liquid polybutadiene rubber, modified liquid polybutadiene rubber, liquid polyisoprene rubber, and modified liquid polyisoprene rubber).

Examples of the above-mentioned plasticizer are those usually used in a field of a rubber industry such as process oil, lubricant, paraffin, liquid paraffin, petroleum asphalt, vaseline, coal tar pitch volatiles, caster oil, flaxseed oil, rubber substitute, beeswax, recinoleic acid, palmitic acid, barium stearate, calcium stearate, zinc laurate, and atactic plypropylene. Among them, particularly preferred is process oil. As already mentioned above, a combination of the component (A) with an oily substance such as process oil is called an extended rubber in the art. The plasticizer is used in an amount of usually 1 to 150 parts by weight, and preferably 2 to 100 parts by weight in order to produce a rubber composition having desired softness, per 100 parts by weight of the total amount of the components (A) and (B).

Examples of the above-mentioned vulcanization accelerator are tetramethylthiuram disulfide, tetraethylthiuram disulfide, tetrabutylthiuram disulfide, dipentamethylenethiuram monosulfide, dipentamethylenethiuram disulfide, dipentamethylenethiuram tetrasulfide, N,N′-dimethyl-N,N′-diphenylthiuram disulfide, N,N′-dioctadecyl-N,N′-diisopropylthiuram disulfide, N-cyclohexyl-2-benzothiazole-sulfenamide, N-oxydiethylene-2-benzothiazole-sulfenamide, N,N-diisopropyl-2-benzothiazole-sulfenamide, 2-mercaptobenzothiazole, 2-(2,4-dinitrophenyl)mercaptobenzothiazole, 2-(2,6-diethyl-4-morpholinothio)benzothiazole, dibenzothiazyl-disulfide, diphenylguanidine, triphenylguanidine, diorthotolylguanidine, orthotolyl-bi-guanide, diphenylguanidine-phthalate, a reaction product of acetaldehyde with aniline, a condensation product of butylaldehyde with aniline, hexamethylenetetramine, 2-mercaptoimidazoline, thiocarbanilide, diethylthiourea, dibutylthiourea, trimethylthiourea, diorthotolylthiourea, zinc dimethyldithiocarbamate, zinc diethyldithiocarbamate, zinc di-n-butyldithiocarbamate, zinc ethylphenyldithiocarbamate, zinc butylphenyldithiocarbamate, sodium dimethyldithiocarbamate, selenium dimethyldithiocarbamate, tellurium diethyldithiocarbamate, zinc dibutylxanthate, and ethylenethiourea. The vulcanization accelerator is used in an amount of usually 0.05 to 20 parts by weight, and preferably 0.1 to 8 parts by weight, per 100 parts by weight of the total amount of the components (A) and (B).

An example of the above-mentioned vulcanizing agent is sulfur, which is used in an amount of usually 0.05 to 5 parts by weight, and preferably 0.1 to 3 parts by weight, per 100 parts by weight of the total amount of the components (A) and (B).

Examples of the above-mentioned vulcanizing auxiliary agent are triallyl isocyanurate, N,N′-m-phenylenebismaleimide, methacrylic acid, methyl methacrylate, ethyl methacrylate, propyl methacrylate, isopropyl methacrylate, n-butyl methacrylate, isobutyl methacrylate, sec-butyl methacrylate, tert-butyl methacrylate, 2-ethylhexyl methacrylate, cyclohexyl methacrylate, isodecyl methacrylate, lauryl methacrylate, tridecyl methacrylate, stearyl methacrylate, 2-hydroxyethyl methacrylate, hydroxypropyl methacrylate, polyethyleneglycol monomethacrylate, polypropyleneglycol monomethacrylate, 2-ethoxyethyl methacrylate, tetrahydrofurfuryl methacrylate, allyl methacrylate, glycidyl methacrylate, benzyl methacrylate, dimethylaminoethyl methacrylate, diethylaminoethyl methacrylate, methacryloxyethyl phosphate, 1,4-butandiol diacrylate, ethyleneglycol dimethacrylate, 1,3-butyleneglycol dimethacrylate, neopentylglycol dimethacrylate, 1,6-hexanediol dimethacrylate, diethyleneglycol dimethacrylate, triethyleneglycol dimethacrylate, polyethyleneglycol dimethacrylate, dipropyleneglycol dimethacrylate, polypropyleneglycol dimethacrylate, trimethylolethane trimethacrylate, trimethylolpropane trimethacrylate, allyl glycidyl ether, N-methylolmethacrylamide, 2,2-bis(4-methacryloxypolyethoxyphenyl)propane, aluminum methacrylate, zinc methacrylate, calcium methacrylate, magnesium methacrylate, and 3-chloro-2-hydroxypropyl methacrylate. The vulcanizing auxiliary agent is used in an amount of usually 0.05 to 15 parts by weight, and preferably 0.1 to 8 parts by weight, per 100 parts by weight of the total amount of the components (A) and (B).

A further example of the above-mentioned vulcanizing auxiliary agent is a metal oxide such as magnesium oxide and zinc oxide. Among them, preferred is zinc oxide, which is used in an amount of usually 1 to 20 parts by weight, per 100 parts by weight of the total amount of the components (A) and (B).

The step (3) is a step of molding the rubber composition produced in the step (2) with a molding machine such as a compression molding machine at usually 120° C. or higher, and preferably 140 to 220° C. for 1 to 60 minutes, thereby decomposing the component (C) contained in the rubber composition, and producing a molded article of a vulcanized rubber composition.

The molded article containing a vulcanized rubber composition can be processed to produce a vibration-proof material, which has a shape suitable for uses such as an engine mount, a muffler hanger and a strut mount.

### EXAMPLE

The present invention is explained with reference to the following Examples, which do not limit the scope of the present invention.

### Example 1

Step (1)

There were kneaded 55 parts by weight of an ethylene-propylene-5-ethylidene-2-norbornene copolymer rubber (component (A)) manufactured by SUMITOMO CHEMICAL Co., Ltd., 45 parts by weight of a natural rubber (component (B)) having a Mooney viscosity (ML₁₊₄ 100° C.) of 60, 5 parts by weight of zinc oxide having a grade name of TWO KIND per 100 parts by weight of the total amount of the components (A) and (B), and 1 part by weight of stearic acid per 100 parts by weight thereof, for 5 minutes, with a 1700 ml-volume Banbury mixer having an initially preset temperature of 80° C. and a rotor rotating speed of 60 rpm, thereby producing a kneaded product, wherein the component (A) contained an ethylene unit in an amount of 52% by weight, and a propylene unit in an amount of 48% by weight, the total amount of both units being 100% by weight, and had a Mooney viscosity (ML₁+₄ 125° C.) of 100, an iodine value of 10, and a trade name of ESPRENE 553.

Step (2)

The above-produced kneaded product, 7 parts by weight of dicumyl peroxide (component (C)) per 100 parts by weight of the total amount of the components (A) and (B), and 0.3 part by weight of sulfur (vulcanizing agent) per 100 parts by weight thereof were mixed with an 8 inch-open roll, thereby producing a rubber composition.

Step (3)

The above-produced rubber composition was press-molded and simultaneously vulcanized at 170° C. for 20 minutes, thereby producing a vulcanized sheet having 2 mm thickness. The sheet can be processed to produce a vibration-proof material having a shape suitable for various uses.

Evaluation of the Above-Produced Vulcanized Sheet

(1) Tensile Strength at High Temperature

According to JIS K 6251 (Japanese Industrial Standards K 6251), there was measured elongation at break of a dumbbell shaped No. 3 specimen made of the above-produced vulcanized sheet, with a laser-style autograph AG-500E manufacture by Shimadzu, at 120° C. (temperature of its atmosphere) and a tensile rate of 500 mm/minute, thereby obtaining the elongation at break of 190%.

(2) High-Temperature Durability

A dumbbell shaped No. 3 specimen was made of the above-produced vulcanized sheet according to JIS K 6251. The specimen was heated at 120° C. for 500 hours according to a normal oven method (JIS K 6257), and then, the specimen was evaluated with QUICK READER P-57 manufacture by Ueshima Seisakusho Co., Ltd. at 23° C. (temperature of its atmosphere) and a tensile rate of 500 mm/minute, thereby obtaining ΔTb of +86%, ΔEb of −53%, and ΔHs of +27 points, wherein ΔTb means a rate of change of tensile strength between before and after said heating, ΔEb means a rate of change of elongation at break between before and after said heating, and ΔHs means a rate of change of hardness between before and after said heating.

Results are summarized in Table 1.

### Example 2

Example 1 was repeated except that 0.5 part by weight of tetramethylthiuram monosulfide (component (D)) per 100 parts by weight of the total amount of the components (A) and (B) was further used in the step (1). Results are summarized in Table 1.

### Comparative Example 1

Example 1 was repeated except that (i) an amount of the component (A) in the step (1) was changed to 100 parts by weight, and (ii) the component (B) therein was not used. Results are summarized in Table 1.

TABLE 1

| | Example | | Comparative |
|---|---|---|---|
| | 1 | 2 | Example 1 |
| Amount used (part by weight) | | | |
| In step (1) | | | |
| Component (A) | 55 | 55 | 100 |
| Component (B) | 45 | 45 | |
| Component (D) | | 0.5 | |
| Zinc oxide | 5 | 5 | 5 |
| Stearic acid | 1 | 1 | 1 |
| In step (2) | | | |
| Component (C) | 7 | 7 | 7 |
| Sulfur | 0.3 | 0.3 | 0.3 |
| Evaluation of vulcanized sheet | | | |
| Elongation at break (%) | 190 | 170 | 110 |
| High-temperature durability | | | |
| ΔTb (%) | +86 | +16 | −26 |
| ΔEb (%) | −53 | +15 | −24 |
| ΔHs (point) | +27 | −1 | +1 |

Based on the above, the elongation at break at high temperature in each of Examples 1 and 2 (190% and 170%, respectively) is larger than that in Comparative Example 1 (110%), and therefore, it is easily understood that a vibration-proof material of the present invention is excellent in its high-temperature durability.

1. A rubber composition, which comprises the following components (A), (B) and (C):
(A) 55 to 95 parts by weight of an ethylene-α-olefin-non-conjugated diene copolymer rubber;
(B) 5 to 45 parts by weight of a natural rubber; and
(C) 0.1 to 15 parts by weight of an organic peroxide, wherein the total amount of the components (A) and (B) is 100 parts by weight, and the rubber composition contains no reinforcing agent.

2. The rubber composition according to claim 1, wherein the rubber composition further comprises 0.05 to 10 parts by weight of tetramethylthiuram monosulfide (component (D)) per 100 parts by weight of the total amount of the components (A) and (B).

3. A process for producing a rubber composition containing no reinforcing agent, which comprises the steps of:
(1) kneading at least the following components (A) and (B),
(A) 55 to 95 parts by weight of an ethylene-α-olefin-non-conjugated diene copolymer rubber, and
(B) 5 to 45 parts by weight of a natural rubber, thereby producing a kneaded product; and
(2) mixing at least the kneaded product with the following component (C),
(C) 0.1 to 15 parts by weight of an organic peroxide, wherein the total amount of the components (A) and (B) is 100 parts by weight.

4. The process for producing a rubber composition containing no reinforcing agent according to claim 3, wherein any of the components (A), (B) and (C) is combined with 0.05 to 10 parts by weight of tetramethylthiuram monosulfide (component (D)) per 100 parts by weight of the total amount of the components (A) and (B).

5. A process for producing a molded article containing a vulcanized rubber composition, which comprises the steps of:
(1) kneading at least the following components (A) and (B),
(A) 55 to 95 parts by weight of an ethylene-α-olefin-non-conjugated diene copolymer rubber, and
(B) 5 to 45 parts by weight of a natural rubber, thereby producing a kneaded product;
(2) mixing at least the kneaded product with the following component (C),
(C) 0.1 to 15 parts by weight of an organic peroxide, thereby producing a rubber composition; and
(3) molding the rubber composition at elevated temperature,
wherein the total amount of the components (A) and (B) is 100 parts by weight, and the rubber composition produced in the step (2) contains no reinforcing agent.

6. The process for producing a molded article containing a vulcanized rubber composition according to claim 5, wherein any of the components (A), (B) and (C) is combined with 0.05 to 10 parts by weight of tetramethylthiuram monosulfide (component (D)) per 100 parts by weight of the total amount of the components (A) and (B).

7. A vibration-proof material, which comprises a molded article containing a vulcanized rubber composition produced by the process according to claim 5.
